(19) United States
(12) Patent Application Publication
(10) Pub. No.: US 2012/0267823 A1
(43) Pub. Date: Oct. 25, 2012

(54) SYSTEM AND METHOD FOR A PNEUMATIC TIRE MOLD

(76) Inventors: Frank Pierre Severens, Arlon (BE); Bernard Marie Henin, Latour (BE); Claude Pierre Georges, Luxembourg (LU); Celal Karabulut, Fameck (FR); Hubert Neuberg, Arlon (BE)

(21) Appl. No.: 13/093,148

(22) Filed: Apr. 25, 2011

(51) Int. Cl. B29D 30/06; B29C 33/38; B23P 11/00; B23K 1/00

(52) U.S. Cl. 264/219; 425/28.1; 228/132; 29/525.01

(57) ABSTRACT

A system for securing a mold blade to a mold segment includes a plurality of pins placed across the length of the mold blade and a plurality of corresponding recesses on an inner surface of the mold segment. Each pin is placed within a recess securing the mold blade to the mold segment.

### FIELD OF THE INVENTION

The present invention is directed to a pneumatic tire curing mold. More particularly, the present invention is directed to a system and method for securing a bottom of a mold blade to the mold.

### BACKGROUND OF THE INVENTION

Conventionally, long circumferential blades have been fixed to tire curing molds by gluing in a recess and providing spot welds on an anchorage foot at each segment end. With the new blades geometries such as a “rain drop blade” or a “blade groove”, the force necessary to remove a cured tire from a mold (e.g., demold) a tire has increased. Correspondingly, the risk that blades tear away from the mold segment has also increased. Thus an improved system or method for securing the blades to the mold segments would be desirable.

### SUMMARY OF THE INVENTION

A system for securing a mold blade to a mold segment in accordance with the present invention includes a plurality of pins placed across the length of the mold blade and a plurality of corresponding recesses on an inner surface of the mold segment. Each pin is placed within a recess securing the mold blade to the mold segment.

In accordance with another aspect of the present invention, each recess is filled by welding.

In accordance with still another aspect of the present invention, an uncured tire is cured by at least one mold segment.

In accordance with yet another aspect of the present invention, the mold blade extends in a circumferential direction around the inner surface of the mold segment.

In accordance with still another aspect of the present invention, the pins extend in a lateral direction about the inner surface of the mold segment.

In accordance with yet another aspect of the present invention, the mold blade extends perpendicularly to the pins.

In accordance with still another aspect of the present invention, the mold blade extends in a lateral direction about the inner surface of the mold segment.

In accordance with yet another aspect of the present invention, the pins extend in a circumferential direction about the inner surface of the mold segment.

A method for securing a mold blade to a mold segment in accordance with the present invention comprises the steps of:

placing a plurality of pins across the length of the mold blade;

placing the pins in a plurality of corresponding recesses on an inner surface of the mold segment; and securing each pin within a recess thereby securing the mold blade to the mold segment.

In accordance with another aspect of the present invention, the method further includes the step of filling each recess by welding.

In accordance with still another aspect of the present invention, the method further includes curing a tire by at least one mold segment.

In accordance with yet another aspect of the present invention, the method further includes the step of extending the mold blade in a circumferential direction around the inner surface of the mold segment.

In accordance with still another aspect of the present invention, the method further includes the step of extending the pins in a lateral direction about the inner surface of the mold segment.

In accordance with yet another aspect of the present invention, the method further includes the step of extending mold blade extends perpendicularly to the pins.

In accordance with still another aspect of the present invention, the method further includes the step of extending the mold blade in a lateral direction about the inner surface of the mold segment.

In accordance with yet another aspect of the present invention, the method further includes the step of extending the pins in a circumferential direction about the inner surface of the mold segment.

### BRIEF DESCRIPTION OF THE DRAWINGS

The present invention will be described by way of example and with reference to the accompanying drawings in which:

FIG. 1 shows a perspective view of an example tread element for use with the present invention;

FIG. 2 shows part of an example mold blade that may be used to form the tread element of FIG. 1;

FIG. 3 shows a cross-sectional view of the example blade of FIG. 2;

FIG. 4 shows a schematic representation of an example mold blade in accordance with the present invention;

FIG. 5 shows a schematic representation of two of the mold blades of FIG. 4 secured to a tire curing mold; and

FIG. 6 shows a schematic isometric of two of the mold blades of FIG. 4 secured to a tire curing mold.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims.

FIG. 1 shows a perspective of an example tread element 10 of a pneumatic tire tread for use with a system and method in accordance with the present invention. The tread element 10 may be formed by at least one groove 12, the groove 12 being either a circumferentially extending or laterally extending groove of the tire tread. If the tread element 10 is defined by only circumferentially extending grooves, the tread element may be a tread rib. If the tread element 10 is formed by grooves on at least three sides, the tread element 10 may be considered a tread block. The tread element 10 may be located in any position on a tread surface (e.g., along a tread shoulder, along the centerline, an intermediate position, etc.). The depth of the grooves 12 forming the example tread element 10 may define the non-skid depth Dₜ of the tire tread. If there are grooves D, Dₜ of differing depths, the maximum groove depth may define the non-skid depth Dₜ of the tread.

At least one sipe 14 may be disposed within the example tread element 10. The sipe 14 may subdivide the tread element 10 into two portions; however, the tread element 10 may alternatively have multiple sipes 14. The sipe 14 may be, for example, straight, curved, or have a general inclination in either the lateral or circumferential direction of the tire.

The sipe 14 may have a radially outer portion 16 having a width d₁ in the range of about 0.3 mm to about 1.0 mm, or more specifically about 0.5 mm to 0.8 mm. The width d₁ may be constant or the width of the radially outer sipe portion may vary. The sipe 14 may further comprise a radially inner portion 18 that has a diameter d₂ which is larger than d₁, and may be in the range of about 1.0 mm to 10.0 mm, or more specifically in the range of about 2.0 mm to about 6.0 mm or in the range of about 2.0 mm to about 4.0 mm. The width range upper limit of the radially inner sipe portion 18 may be limited by the ability to demold the tire and remove the forming blade without destroying the radially outer sipe portion 16 of the tire.

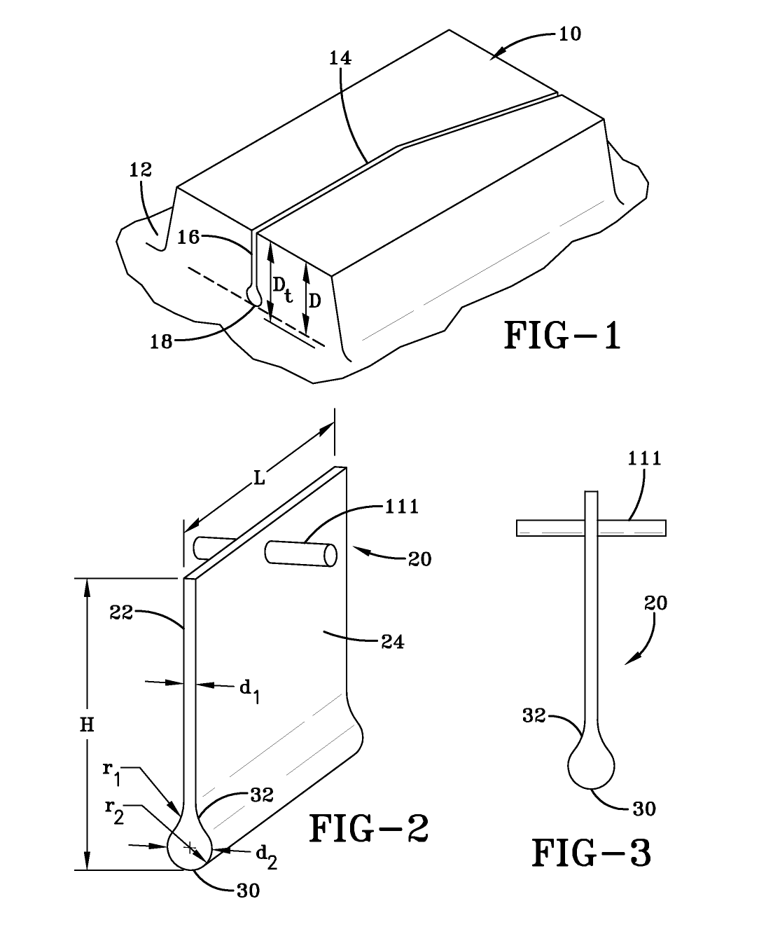

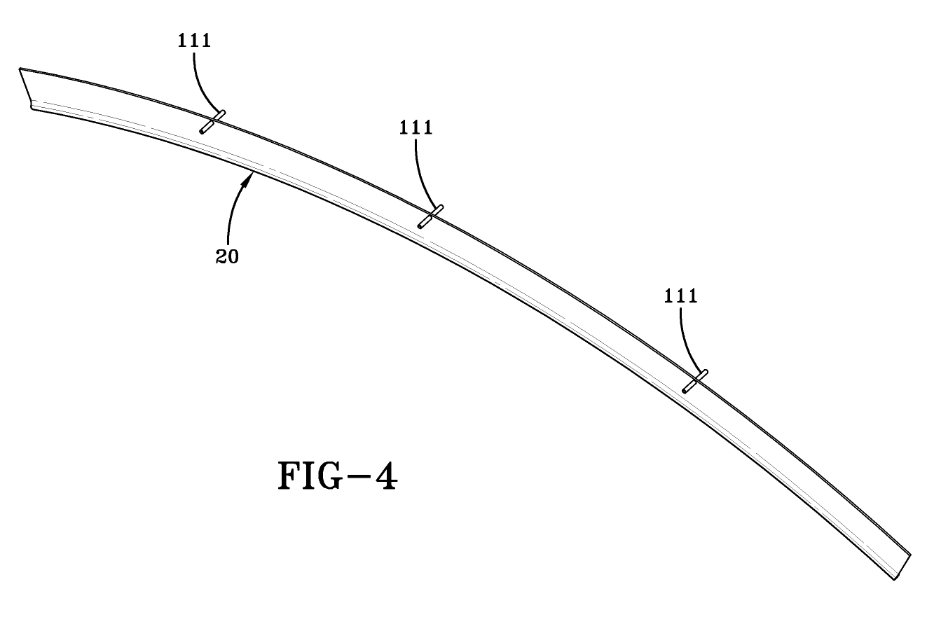

The sipe 14 may be formed from a mold blade 20, an example of which is partially shown in FIG. 2. During molding/curing of the tire tread, the blade 20 may form the sipe 14 that has a profile corresponding to the blade profile. The example blade 20 may be formed of a metal such as steel. The blade 20, depending upon the shape, may be direct milled, cast, or formed by stamping or embossing. The blade 20 may comprise a first radially outer portion 22 that has a width d₁ in a range of about 0.3 mm to about 0.8 mm, and more specifically about 0.5 mm to 0.8 mm. The width d₁ may be constant or the radially outer blade portion may vary. The first portion 22 may be formed from a flat, planar plate 24 having a defined length L, height H, and width/thickness d₁. The first portion 22 may also be curved or have three dimensional projections, or combinations thereof.

The mold blade 20 may further comprise a second portion 30 located at a radially inner end of the plate 24 (e.g., the base of the sipe of the tire tread). The second portion 30 may, for example, comprise an enlarged, rounded cross section or bulbous shape (e.g., the shape of a falling rain drop). The second portion 30 may be interconnected with the first portion 22 without corners or discontinuities. The second portion 30 may, for example, transition from the first portion 22 by a radiused smooth surface 32 having its center located outside the second portion 30. The surface 32 may comprise a radius r₁ in the range of about 0.5 mm to about 8.0 mm, and more specifically in the range of about 1.0 mm to about 3.0 mm. A radius r₂ of the second portion 30 may range from about 0.5 mm to about 5.0 mm, or more specifically from about 1.5 mm to about 2.5 mm. The ratio of the transition radius to the second portion radius r₁/r₂ may range from about 0.1 mm to about 16.0 mm, or more specifically from about 0.3 mm to about 4.0 mm.

Conventionally, long, circumferentially extending mold blades have been secured to tire molds by gluing the blade in a corresponding circumferentially extending recess in the tire mold and spot welding each end of the blade to the tire mold. With the advent of varying blade geometries, such as “rain drop blade” or “blade groove ” (FIGS. 2 & 3), the force necessary to demold a tire from the tire mold has also increased, thereby increasing the frequency of the blade tearing away from the tire mold during demolding. A system and method in accordance with the present invention may provide increased anchoring for securing mold blades to tire molds.

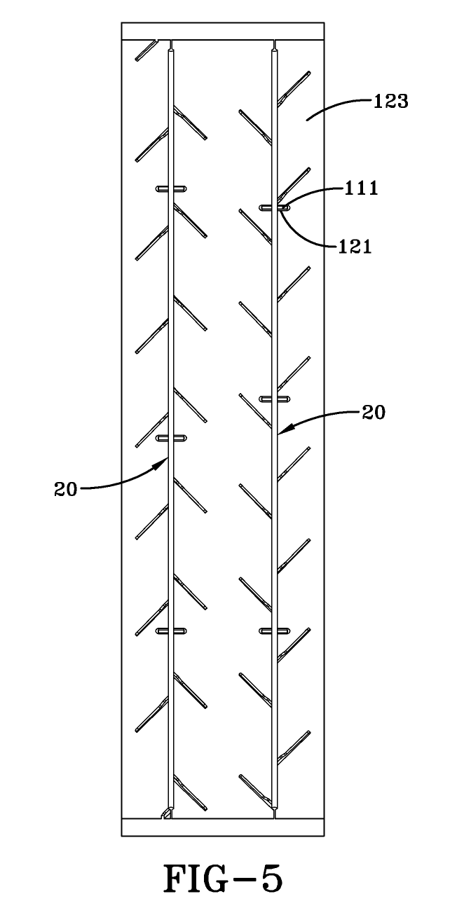

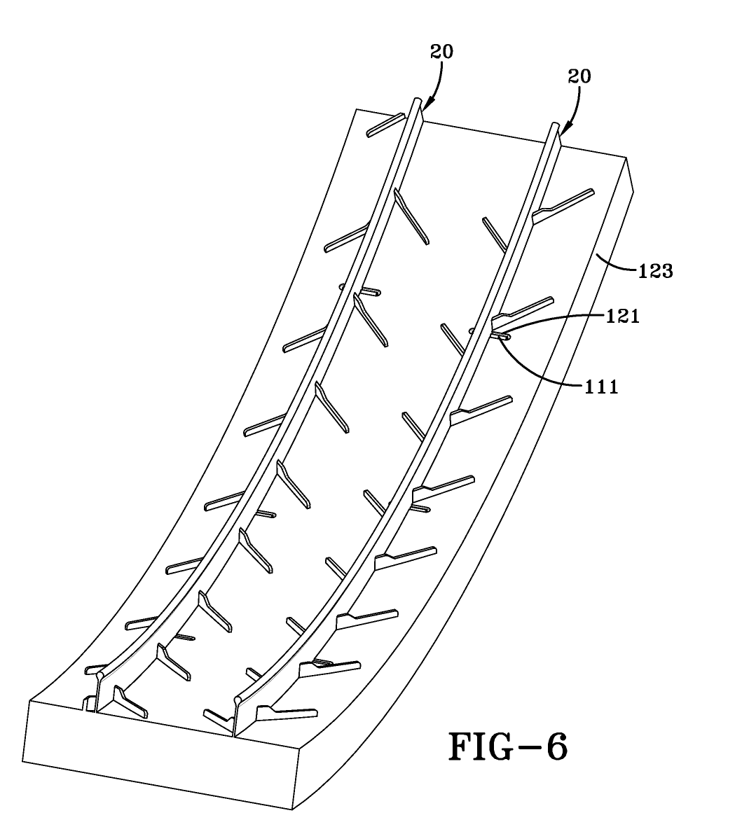

The system and method may provide several pins 111 (three in FIG. 4) placed across the length of the blade 20 and secured perpendicularly thereto; and several recesses 121 corresponding to the pins, each recess on the inner surface of the mold segment 123. Each pin 111 may be placed within a recess 121. Each recess 121 (six in FIGS. 5 & 6) may then be filled by welding thereby securing the blade 20 to the mold segment 123. The mold segment 123 may be buffed and used in a curing press. Alternatively, the mold blade 20 may extend laterally and the pins 111 may extend circumferentially (e.g., for forming lateral grooves in a tire tread).

While a certain representative embodiment and details have been shown for the purpose of illustrating the invention, it will be apparent to those skilled in the art that various changes and modifications may be made therein without departing from the spirit or scope of the invention.

1. A system for securing a metal mold blade to a mold segment comprising:
a plurality of metal pins placed across the length of the metal mold blade and extending laterally and perpendicularly relative to the metal mold blade; and
a plurality of corresponding recesses on an inner surface of the mold segment, each pin placed within a recess filled by welding for securing the metal mold blade to the mold segment,
the metal mold blade including a first portion and a second portion extending radially inward from the first portion,
the first portion having a constant thickness between 0.5 mm and 0.8 mm, and
the second portion having an enlarged and rounded shape with a radius between 1.5 mm and 2.5 mm and a transition radius from the first portion between 1.0 mm and 3.0 mm.

2. (canceled)

3. The system as set forth in claim 1 wherein an uncured tire is cured by at least one mold segment.

4. The system as set forth in claim 3 wherein the mold blade extends in a circumferential direction around the inner surface of the mold segment.

5. (canceled)

6. (canceled)

7. (canceled)

8. (canceled)

9. A method for securing a metal mold blade to a mold segment comprising the steps of:
extending the metal mold blade in a circumferential direction around an inner surface of a mold segment;
extending a plurality of metal pins in a lateral direction about the inner surface of the mold segment;
placing the plurality of metal pins across the length of the metal mold blade;
placing each metal pin in a plurality of corresponding recesses on the inner surface of the mold segment; and
welding each metal pin by filling a corresponding recess thereby securing the metal mold blade to the mold segment.

10. (canceled)

11. (canceled)

12. (canceled)

13. (canceled)

14. (canceled)

15. (canceled)

16. (canceled)
